(19) United States
(12) Patent Application Publication
(10) Pub. No.: US 2015/0096328 A1
(43) Pub. Date: Apr. 9, 2015

(54) ACCESSORY ITEM FOR ORNAMENTS HAVING ELECTRICALLY ACTUATED FEATURES

(71) Applicant: Dylan Schwartz, Las Vegas, NV (US)

(72) Inventor: Dylan Schwartz, Las Vegas, NV (US)

(21) Appl. No.: 14/508,817

(22) Filed: Oct. 7, 2014

Related U.S. Application Data
(60) Provisional application No. 61/887,840, filed on Oct. 7, 2013.

(51) Int. Cl. A44C 15/00; H02J 1/06

(52) U.S. Cl. CPC A44C 15/0015; H02J 1/06
USPC 63/1.13; 63/1.11

(57) ABSTRACT

An article of jewelry for connecting an ornament having an electrically actuated feature thereto, comprising at least one ornament connection port mounted on a support substrate, the ornament receiving port being in electrical communication with an electrical conductor and comprising a post receiving cavity extending axially into the substrate, the post receiving cavity defining an bottom surface and an opening, wherein an axially inner electrically conductive member is mounted adjacent to the bottom surface of the post receiving cavity and an axially outer electrically conductive member is mounted adjacent to the opening of the cavity, the outer electrically conductive member being configured to provide a negative electrical contact and the inner conductive member being configured to provide a positive electrical contact responsive to the formation of a non-permanent engagement between first and second substrate engagement members.

### CROSS-REFERENCE TO RELATED APPLICATIONS

This application claims the benefit of U.S. Provisional Patent Application No. 61/887,840 which was filed Oct. 7, 2013, the disclosure of which is incorporated herein by reference.

### BACKGROUND

The invention is directed to novelty items with ornamental and utilitarian features, such as wearable accessories that include electrically actuated features.

### SUMMARY OF THE INVENTION

The invention is generally directed to an article of jewelry for connecting an ornament having an electrically actuated feature thereto, comprising: a flexible support substrate; first and second substrate engagement members mounted on the support substrate, the first and second substrate engagement members being configured to form a non-permanent engagement with one another; an electrical conductor mounted in the support substrate, the electrical conductor being operatively associated with the first and second engagement members, wherein an electrical circuit is created by the formation of the non-permanent engagement; a battery mounted in the support substrate and in electrical communication with the electrical conductor; and at least one ornament connection port mounted on the support substrate, the ornament receiving port being in electrical communication with the electrical conductor and comprising a post receiving cavity extending axially into the substrate, the post receiving cavity defining an bottom surface and an opening, wherein an axially inner electrically conductive member is mounted adjacent to the bottom surface of the post receiving cavity and an axially outer electrically conductive member is mounted adjacent to the opening of the cavity, the outer electrically conductive member being configured to provide a negative electrical contact and the inner conductive member being configured to provide a positive electrical contact responsive to the formation of the non-permanent engagement between the first and second substrate engagement members.

In some embodiments, the support substrate further comprises an elongated body having a first end, a second end and an intermediate section between the first end and the second end.

In some embodiments, the first substrate engagement members are mounted at the first end and the second substrate engagement member is mounted at the second end.

In some embodiments, formation of the non-permanent engagement positions the substrate in a annular configuration with the ornament receiving ports on the outer surface.

In some embodiments, the electrical conductor comprises flexible electrically conductive wires.

In some embodiments, the support substrate comprises a plurality of layers of flexible non-electrically conductive material.

In some embodiments, the electrical conductor and battery are mounted to one or more inner layers of the substrate.

In some embodiments, the axially outer electrically conductive member comprises a retractable member biased towards the center axis of the cavity, whereby the retractable member engages a post received in the cavity.

In some embodiments, the receiving cavity of the ornament connection port includes a threaded inner surface configured to receive a corresponding threaded post.

In some embodiments, the inner electrically conductive member comprises an axially biased post extending into the cavity.

In some embodiments, the first engagement member comprises a post receiving cavity extending axially into the substrate, the post receiving cavity defining an bottom surface and an opening, wherein an axially inner electrically conductive member is mounted adjacent to the bottom surface of the post receiving cavity and an axially outer electrically conductive member is mounted adjacent to the opening of the cavity, the outer electrically conductive member being configured to provide a negative electrical contact and the inner conductive member being configured to provide a positive electrical contact responsive to the formation of the non-permanent engagement between the first and second substrate engagement members.

In some embodiments, the second engagement member includes a post having a proximal portion and a distal portion, the distal portion including an distal electrically conductive member and the proximal portion including a proximal electrically conductive member, wherein the distal electrically conductive member contacts the inner electrically conductive member within the cavity and the proximal electrically conductive member contacts the outer electrically conductive member mounted responsive to the formation of the non-permanent engagement.

In some embodiments, the article of jewelry further comprises an ornament including a base defining a first and second generally opposing sides, the first side of the base including a post having a proximal portion and a distal portion, the distal portion including an distal electrically conductive member and the proximal portion including a proximal electrically conductive member, wherein the distal electrically conductive member contacts the inner electrically conductive member within the cavity and the proximal electrically conductive member contacts the outer electrically conductive member mounted responsive to being connected to the ornament receiving port, and the second side including an electrically actuated feature, the electrically actuated feature being actuated responsive to the ornament being connected to the ornament receiving port and the formation of the non-permanent engagement between the first and second engagement members.

In some embodiments, the electrically actuated feature is an illumination device.

In some embodiments, the illumination device is a LED.

In some embodiments, the illumination device includes a transparent cover.

In some embodiments, the electrically actuated feature is an audio device.

### BRIEF DESCRIPTION OF THE DRAWINGS

FIG. 1 is a perspective view of an exemplary embodiment of the invention illustrating the embodiment in the non-permanent engagement configuration in which an electrical circuit is formed, with ornaments in the ornament connection ports;

FIG. 2 is a top view of the embodiment shown in FIG. 1 illustrating the open, unengaged configuration of the embodiment, with no ornaments in the ornament connection ports; and

FIG. 3 is a close up view of an ornament and the ornament connection port of the embodiment of the invention shown in FIG. 1.

### DETAILED DESCRIPTION OF THE INVENTION

Although the drawings and description below is directed to a bracelet, the invention may also be embodied in and by other items, such as clothing or accessories which may be worn on the body, such as for example, hats, gloves, scarves, necklaces, earrings, anklets, armbands, clothing or pins.

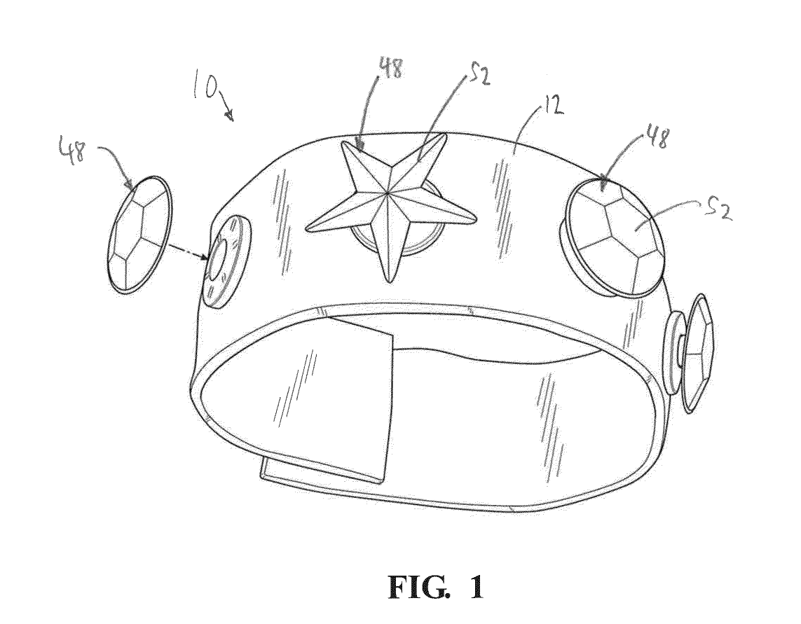

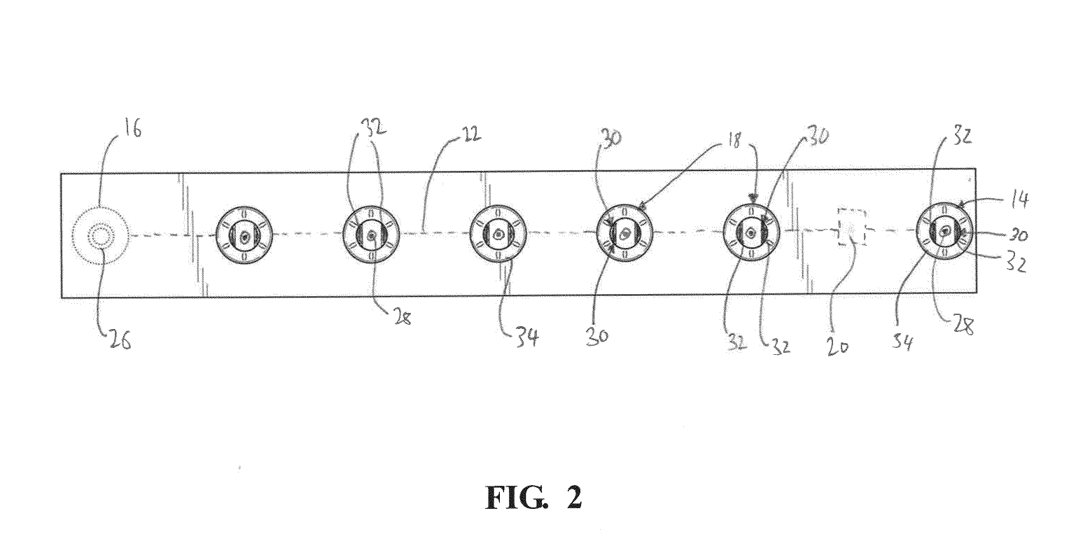

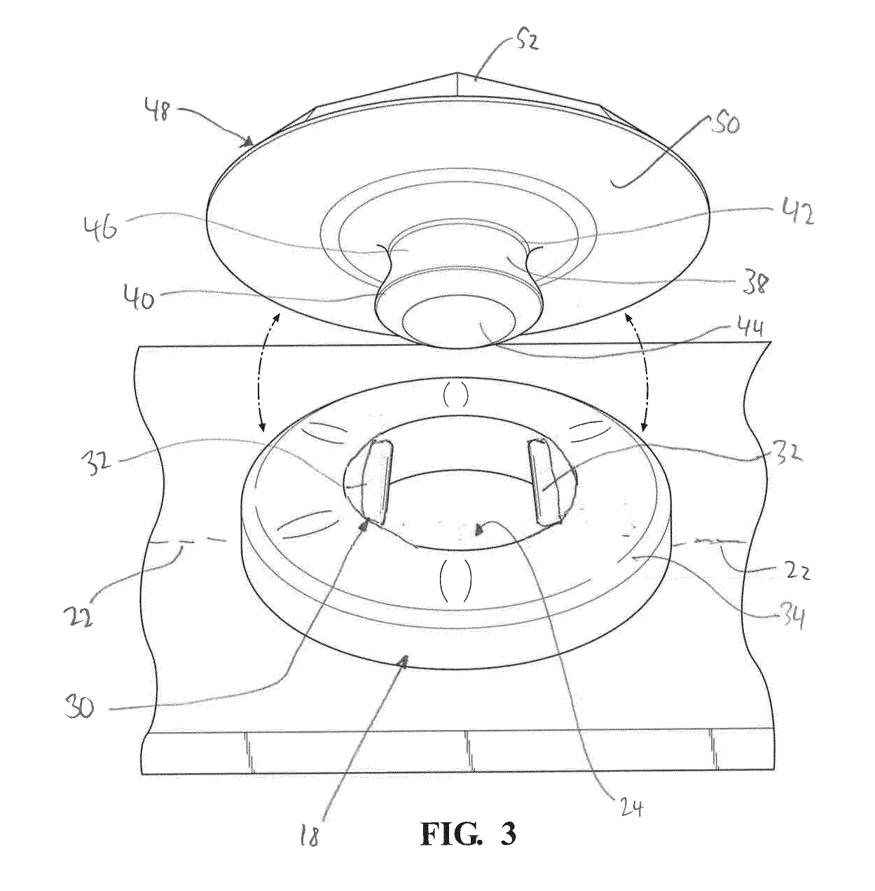

An exemplary embodiment of the invention is shown in FIGS. 1-3 and generally referred to by the reference numeral 10. For ease of description, this embodiment will be referred to as bracelet 10. Bracelet 10 includes a support substrate 12, which may be comprised of layers of flexible aesthetically pleasing, insulation or dielectric materials, first and second substrate engagement members 14 and 16 and ornament connection ports 18. A battery 20 and electrical conductor 22 is mounted within support substrate 12 to be covered by dielectric material to be in communication with one another. It should be understood that electrical conductor 22 may comprise one or more flexible electrically conductive materials and battery 20 may be of any type, such as a long-lasting provider of low voltage current. In the open configuration shown in FIG. 2, electrical conductor 22 is in communication with battery 20 but the circuit is not activated in that the electrical loop is not formed.

In this embodiment, first and second substrate engagement members 14 and 16 are corresponding snap fitting components, that is, first substrate engagement member 14 includes a female post receiving cavity 24 and second substrate engagement member 16 includes a corresponding male post 26 for being inserted therein to form a non-permanent engagement as shown in FIG. 1. Cavity 24 extends axially into substrate 12 with respect to the plane of its surface.

First engagement member 14 includes an inner electrically conductive member 28 mounted within cavity 24 and outer electrically conductive member 30. Member 28 is in electrical communication with conductor 22 to form an electrically positive contact. In this embodiment, member 28 is shaped as a post, mounted at the bottom surface of the cavity, which is biased, by spring or other biasing mechanism, in an axial direction into the interior space of cavity 24. Outer electrically conductive member 30 is mounted adjacent to the opening of the cavity and in electrical communication with conductor 22 to form an electrically negative contact or ground. In this embodiment, member 30 is shaped as dual planar arms 32 which are biased, by spring or other biasing mechanism, in a radial direction into the interior space of cavity 24. A collar 34 is mounted on substrate 12 over the rim of cavity 24. Inner member 28 and outer member 30 may be electrically separated by a dielectric or insulating material in cavity 24.

Second engagement member 16 includes an outer annular member 36 which is configured and dimensioned to fit over collar 24 and an axial post 38 extending from the surface of substrate 12. Post 38 includes a distal portion 40 and a proximal portion 42. Distal portion 40 includes an distal electrically conductive member 44 in electrical communication with electrical conductor 22 to form an electrically positive contact and proximal portion 42 includes a proximal electrically conductive member 46 in electrical communication with electrical conductor 22 to form an electrically negative contact responsive to forming the non-permanent engagement between the first and second engagement members 16 and 18 as shown in FIG. 1. Distal member 44 and proximal member 46 may be electrically separated by a dielectric or insulating portion of post 38.

In this embodiment, ornament connection ports 18 are constructed in the same manner as first engagement member 14. An ornament 48 with an electrically actuated feature, in this embodiment a light emitting diode or LED mounted on a base 50 within a decorative transparent or colored material cover 52 includes a post in the same configuration as post 38. Thus, post 38 extends from base 50 and is inserted into a cavity 24 of a port 18 in the same manner as described above. The electrically actuated feature of ornament 48 is actuated responsive to the connection of an ornament 48 with a port 18 and the formation of a non-permanent engagement between the first and second substrate engagement members 14 and 16. It should be understood that cover 52 may be in any aesthetically pleasing shape, such as a diamond or star, or may include indicia such as letters, words, pictures or other characters.

The support substrate may also include a control device or processor for controlling other features, such as the rate, color or intensity of illumination.

In the example shown herein, the ornament may be snap fit into the port. In other embodiments, the cavity may include a threaded portion which enables an ornament to be screwed into corresponding threads in the cavity.

It should be readily apparent that many features of the invention may be varied while still remaining in the scope of the invention. The invention disclosed herein can be used for accessories such as jewelry, such as earrings, necklaces, bracelets, pedants, anklets, or other body jewelries, or it can also be applied to any article of clothing, shoes, etc. The apparatus of the invention can be applied to purses, handbags, satchels, briefcases, laptop cases, etc. The apparatus can also be applied to jeans, shirts, skirts, blouses, underwear, glasses, belts, buckles, tie clips, cuff links, shoes, hat, hatband, frames, artworks, wine glass identifiers, napkin holders, flashlight, nightlight, key ring, door handle to cars, interior light runner in cars, laptops, cellular phones, furniture, household goods such as chairs and tables, fixtures, chandeliers, etc.

Although the present invention describes several types of jewelry in particular, other uses can also be implemented without departing form the spirit of the present invention, such as collars, mouse pad and clothing buttons. Furthermore, the apparatus disclosed herein can be used on straps for carrying items, ties, cuffs, bracelets, brooches, tie clips, earrings, belts, hair or headband, wine glass charms, napkin holders, and key rings, among other items. Therefore, while the embodiments of the present invention have been described or mentioned in connection with particular examples thereof, the true scope of the embodiments of the invention should not be so limited since other modifications, whether explicitly provided for by the specification or implied by the specification, will become apparent to the skilled practitioner upon a study of the drawings and specification.

The foregoing described embodiments of the invention are provided as illustrations and descriptions of the invention. They are not intended to limit the invention to the precise forms described. In particular, it is contemplated that functional implementations of the invention described herein may be constructed of varying materials and different arrangements. Other variations and embodiments are possible in light of above teachings, and nothing contained herein should be construed as limiting the scope of invention as set forth by the claims and equivalents thereto.

What is claimed is:

1. An article of jewelry for connecting an ornament having an electrically actuated feature thereto, comprising:
a) a flexible support substrate;
b) first and second substrate engagement members mounted on the support substrate, the first and second substrate engagement members being configured to form a non-permanent engagement with one another;
c) an electrical conductor mounted in the support substrate, the electrical conductor being operatively associated with the first and second engagement members, wherein an electrical circuit is created by the formation of the non-permanent engagement;
d) a battery mounted in the support substrate and in electrical communication with the electrical conductor; and
e) at least one ornament connection port mounted on the support substrate, the ornament receiving port being in electrical communication with the electrical conductor and comprising a post receiving cavity extending axially into the substrate, the post receiving cavity defining an bottom surface and an opening, wherein an axially inner electrically conductive member is mounted adjacent to the bottom surface of the post receiving cavity and an axially outer electrically conductive member is mounted adjacent to the opening of the cavity, the outer electrically conductive member being configured to provide a negative electrical contact and the inner conductive member being configured to provide a positive electrical contact responsive to the formation of the non-permanent engagement between the first and second substrate engagement members.

2. The article of jewelry as recited in claim 1, wherein the support substrate further comprises an elongated body having a first end, a second end and an intermediate section between the first end and the second end.

3. The article of jewelry as recited in claim 2, wherein the first substrate engagement members are mounted at the first end and the second substrate engagement member is mounted at the second end.

4. The article of jewelry as recited in claim 1, wherein formation of the non-permanent engagement positions the substrate in a annular configuration with the ornament receiving ports on the outer surface.

5. The article of jewelry as recited in claim 1, wherein the electrical conductor comprises flexible electrically conductive wires.

6. The article of jewelry as recited in claim 1, wherein the support substrate comprises a plurality of layers of flexible non-electrically conductive material.

7. The article of jewelry as recited in claim 6, wherein the electrical conductor and battery are mounted to one or more inner layers of the substrate.

8. The article of jewelry as recited in claim 1, wherein the axially outer electrically conductive member comprises a retractable member biased towards the center axis of the cavity, whereby the retractable member engages a post received in the cavity.

9. The article of jewelry as recited in claim 1, wherein the receiving cavity of the ornament connection port includes a threaded inner surface configured to receive a corresponding threaded post.

10. The article of jewelry as recited in claim 1, wherein the inner electrically conductive member comprises an axially biased post extending into the cavity.

11. The article of jewelry as recited in claim 1, wherein the first engagement member comprises a post receiving cavity extending axially into the substrate, the post receiving cavity defining an bottom surface and an opening, wherein an axially inner electrically conductive member is mounted adjacent to the bottom surface of the post receiving cavity and an axially outer electrically conductive member is mounted adjacent to the opening of the cavity, the outer electrically conductive member being configured to provide a negative electrical contact and the inner conductive member being configured to provide a positive electrical contact responsive to the formation of the non-permanent engagement between the first and second substrate engagement members.

12. The article of jewelry as recited in claim 11, wherein the second engagement member includes a post having a proximal portion and a distal portion, the distal portion including an distal electrically conductive member and the proximal portion including a proximal electrically conductive member, wherein the distal electrically conductive member contacts the inner electrically conductive member within the cavity and the proximal electrically conductive member contacts the outer electrically conductive member mounted responsive to the formation of the non-permanent engagement.

13. The article of jewelry as recited in claim 1, further comprising an ornament including a base defining a first and second generally opposing sides, the first side of the base including a post having a proximal portion and a distal portion, the distal portion including an distal electrically conductive member and the proximal portion including a proximal electrically conductive member, wherein the distal electrically conductive member contacts the inner electrically conductive member within the cavity and the proximal electrically conductive member contacts the outer electrically conductive member mounted responsive to being connected to the ornament receiving port, and the second side including an electrically actuated feature, the electrically actuated feature being actuated responsive to the ornament being connected to the ornament receiving port and the formation of the non-permanent engagement between the first and second engagement members.

14. The article of jewelry as recited in claim 13, wherein the electrically actuated feature is an illumination device.

15. The article of jewelry as recited in claim 14, wherein the illumination device is a LED.

16. The article of jewelry as recited in claim 14, wherein the illumination device includes a transparent cover.

17. The article of jewelry as recited in claim 13, wherein the electrically actuated feature is an audio device.
